(19) United States
(12) Patent Application Publication
(10) Pub. No.: US 2003/0206638 A1
(43) Pub. Date: Nov. 6, 2003

(54) Increasing peer privacy by forwarding a label

(76) Inventors: Zhichen Xu, Palo Alto, CA (US); Li Xiao, Williamsburg, VA (US)

Correspondence Address: HEWLETT-PACKARD COMPANY, Intellectual Property Administration, P.O. Box 272400, Fort Collins, CO, 80527-2400, US

(21) Appl. No.: 10/135,413

(22) Filed: May 1, 2002

(51) Int. Cl. H04L 9/00

(52) U.S. Cl. 380/281

(57) ABSTRACT

In a method for increasing peer privacy, a path for information is formed from a provider to a requestor through a plurality of peers in response to a received request for the information. Each peer of the plurality of peers receives a respective set-up message comprising of a predetermined label and an identity of a next peer for the information. The information is transferred over the path in a message, where the message comprises a message label configured to determine a next peer according to the path in response to the message label matching the previously received predetermined label.

### FIELD OF THE INVENTION

This invention relates generally to network systems. More particularly, the invention relates to increasing peer privacy in a network system.

### DESCRIPTION OF THE RELATED ART

A conventional system of peers (or network nodes) interconnected via a network provides a relatively convenient means of exchanging information between the peers. However, conventional network systems may be vulnerable to malicious users. For example, malicious users may determine the types of information stored at specific peers by monitoring the traffic on the network. This may be problematic if one or more of the peers is a source of sensitive information.

Most existing anonymity techniques are for client/server models, which only hide the identities of the requestor (clients) from the servers. Some recent techniques have addressed the problem of enforcing the mutual anonymity between a requestor and responder in a peer-to-peer (“P2P”) environment. One technique to substantially increase privacy in a P2P network system is to configure each peer such that it only knows a limited number of other peers. Accordingly, the identity of each peer is hidden from the other network nodes. However, this technique may suffer from some drawbacks and disadvantages. For instance, a peer may have to blindly broadcast its anonymous request for information to a large number of the peers. As a result, each peer receiving the request may search for the requested information. A majority of the peers may not have the requested information but are still required to process the request, and thereby, waste computational time.

Another technique to substantially increase privacy in a conventional network system is to use a trusted third party to hide the identity of the peer. However, this approach also has its own drawbacks and disadvantages. For example, the trusted third party may become a bottleneck for network traffic since the requests for information are funneled through the trusted third party. As a result, the overall performance of the conventional network system may be substantially reduced.

### SUMMARY OF THE INVENTION

An embodiment of the present invention pertains to a method of increasing privacy in a network system. The method includes selecting a label in response to a request for information, the label configured to indicate a pre-determined path through a plurality of peers for the information and forwarding the label to form a communication channel through the plurality of peers. The method also includes transmitting the information through the communication channel.

Another embodiment of the invention relates to a method of increasing privacy in a network. The method includes generating a plurality of paths, where each path is configured to include a number of peers and each path is configured to have a respective path name and determining a sub-plurality of paths associated with a selected peer. The method also includes determining a plurality of subsequent peers, each subsequent peer following the selected peer according to a respective path of the sub-plurality of paths and creating a plurality of path segments for the selected peer, where each path segment comprises each subsequent peer of each path of the sub-plurality of paths and the respective path name of each path.

Yet another embodiment of the present invention pertains to a method of communicating with increased privacy. The method includes transmitting a label for a selected path and receiving the label at a current peer. The method also includes forming a persistent connection link of a communication channel from the current peer to a previous peer and retrieving an identity of a peer following the current peer from a table of the current peer with the label as a current search index. The method further includes transmitting the label to the peer following the current peer.

Yet another embodiment of the present invention relates to a system for increasing privacy. The system includes a plurality of peers, a directory, and a privacy module executing on the directory. The privacy module is configured to select a label in response to a request for information, where the label is configured to indicate a pre-determined path through a plurality of peers for the information. The privacy module is also configured to forward the label to form a communication channel through the plurality of peers and to transmit the information through the communication channel.

Yet another embodiment of the present invention pertains to a system for increasing privacy. The system includes a plurality of peers, a directory, and a privacy module executing on the directory. The privacy module is configured to generate a plurality of paths, where each path is configured to include a number of peers and each path is configured to have a respective path name. The privacy module is also configured to determine a sub-plurality of paths associated with a selected peer and to determine a plurality of subsequent peers. Each subsequent peer follows the selected peer according to a respective path of the sub-plurality of paths. The privacy module is further configured to create a plurality of path segments for the selected peer. Each path segment includes each subsequent peer for each path of the sub-plurality of paths and the respective path name of each path.

Yet another embodiment of the present invention relates to an apparatus for communicating with increased privacy. The apparatus includes means for transmitting a label for a selected path and means for receiving the label at a current peer. The apparatus also includes means for forming a persistent connection link of a communication channel from the current peer to a previous peer and means for retrieving an identity of a peer following the current peer from a table of the current peer with the label as a current search index. The apparatus further includes means for transmitting the label to the peer following the current peer.

Yet another embodiment of the present invention pertains to an apparatus for increasing privacy in a network system. The apparatus includes means for selecting a label in response to a request for information, where the label is configured to indicate a predetermined path through a plurality of peers for the information. The apparatus also includes means for forwarding the label to form a communication channel through the plurality of peers and means for transmitting the information through the communication channel.

Yet another embodiment of the present invention relates to an apparatus for increasing privacy in a network. The apparatus includes means for generating a plurality of paths, where each path is configured to include a number of peers and each path is configured to have a respective path name. The apparatus also includes means for determining a sub-plurality of paths associated with a selected peer and means for determining a plurality of subsequent peers, each subsequent peer following the selected peer according to a respective path of the sub-plurality of paths. The apparatus further includes means for creating a plurality of path segments for the selected peer. Each path segment includes each subsequent peer of each path of the sub-plurality of paths and the respective path name of each path.

### BRIEF DESCRIPTION OF THE DRAWINGS

Various features of the present invention can be more fully appreciated as the same become better understood with reference to the following detailed description of the present invention when considered in connection with the accompanying figures, in which:

FIG. 1 illustrates an exemplary system where an embodiment of the invention may be practiced;

FIG. 2 illustrates an exemplary architecture for a directory in the system shown in FIG. 1 in accordance with one embodiment of the invention;

FIGS. 3A-B collectively illustrate exemplary embodiments of a global path table shown in FIG. 2 in accordance with one embodiment of the present invention;

FIG. 4 illustrates an exemplary flow diagram according to an embodiment of the invention;

FIG. 5 illustrates an exemplary flow diagram according to another embodiment of the invention;

FIG. 6 illustrates an exemplary architecture for a peer in the system shown in FIG. 1 in accordance with one embodiment of the invention;

FIGS. 7A-B collectively illustrate exemplary local hash tables according to yet another embodiment of the invention;

FIG. 8 illustrates an exemplary flow diagram according to yet another embodiment of the invention;

FIG. 9 illustrates an exemplary flow diagram according to yet another embodiment of the invention; and

FIG. 10 illustrates an exemplary computer system where an embodiment of the present invention may be practiced.

### DETAILED DESCRIPTION OF A PREFERRED EMBODIMENT

For simplicity and illustrative purposes, the principles of the present invention are described by referring mainly to an exemplary embodiment thereof. However, one of ordinary skill in the art would readily recognize that the same principles are equally applicable to, and can be implemented in, all types of network systems, and that any such variations do not depart from the true spirit and scope of the present invention. Moreover, in the following detailed description, references are made to the accompanying figures, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment of the present invention, a privacy module may be utilized to increase the privacy of peers exchanging information in a network system. The network system comprises a plurality of peers, a directory (i.e., a trusted-third-party), and a network providing a communication channel for the peers to communicate among the peers and the directory. A requestor peer may be configured to query the directory for information, where the query may take the form of a message (or packet, signal, etc.). The directory, acting as a trusted-third-party (i.e., configured not to reveal identities and/or modify information), may search an associated database for the availability of the requested information. If the information is available on a peer (a provider peer), the directory may be configured to randomly select a path from the provider peer to the requestor peer from a global path table, i.e., a data structure maintaining a plurality of paths between peers, each path indexed by a corresponding unique label, i.e., a path label name. The directory may also be configured to transmit a retrieval message to the provider peer. The retrieval message may comprise the selected path label and an encryption key encrypted with the public key of the provider peer.

For a selected peer, the directory may be further configured to analyze the paths that include the selected peer in accordance with another embodiment of the present invention. More particularly, the directory may determine the peer following the selected peer according to each path, i.e., the directory may form a tuple composed of a path label name and the identity of the peer following the selected peer according to the path. When the tuples are formed for a selected peer, the tuples are transmitted to the selected peer. The selected peer may then store the received tuples in a data structure such as a hash table, a linked list, etc., on the selected peer. The creation and transmission of the tuples may be conducted for each peer in the plurality of peers.

In accordance with another embodiment of the present invention, a provider peer that receives the retrieval message from the directory may search a local hash table with the label as a search index. The provider peer may then be configured to transmit a set-up message to the retrieved next peer. The set-up message may comprise the selected path label name.

An intermediary peer may be configured to receive a set-up message in accordance with yet another embodiment of the present invention. The intermediary peer may be configured to set up a persistent communication connection between the intermediary peer and the peer that transmitted the set-up message. The intermediary peer may also be configured to search its respective hash table for the next peer based on the path label contained in the set-up message. If the search returns a null value, the intermediary peer determines that it is the final destination and will send an acknowledgement message to the provider peer to forward the requested information. Otherwise, if the search returns the identity of the next peer, the intermediary message forwards the set-up message to the identified next peer.

The provider peer may be further configured to transmit the encryption key generated by the directory encrypted with the public key of the requester and the requested information encrypted with the encryption key in response to receiving the acknowledgement message from the requestor peer. Accordingly, a peer privacy module may be utilized to protect the identities of a requestor and provider of information.

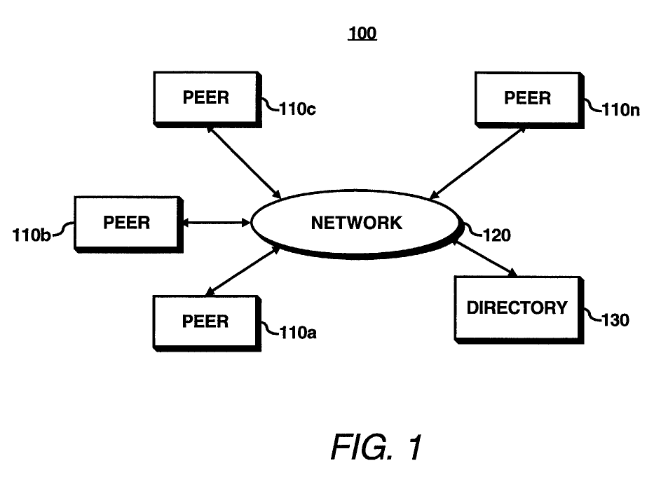

FIG. 1 illustrates an exemplary block diagram of a system 100 where an embodiment of the present invention may be practiced. It should be readily apparent to those of ordinary skill in the art that the system 100 depicted in FIG. 1 represents a generalized schematic illustration and that other components may be added or existing components may be removed or modified without departing from the spirit or scope of the present invention.

As shown in FIG. 1, the system 100 includes a plurality of peers 110a . . . 110n. The peers 110a . . . 110n may be configured to exchange information among themselves and with other network nodes over a network 120. The peers 110a . . . 110n may also be configured to determine which peers 110a . . . 110n are valid. The peers 110a . . . 110n may be computing platforms (e.g., personal digital assistants, laptop computers, workstations, and other similar devices) that have a network interface. The peers 110a . . . 110n may each be further configured to execute an application software program that provides the capability to share information (e.g., files, data, applications, etc.) in a peer-to-peer manner. Examples of a peer-to-peer software applications are KAZAA, NAPSTER, MORPHEUS, or other similar peer-to-peer applications.

The network 120 may be configured to provide a communication channel among the peers 110a . . . 110n. The network 120 may be implemented as a local area network, wide area network or a combination thereof. The network 120 may implement wired protocols such as Ethernet, token ring, etc., wireless protocols such as Cellular Digital Packet Data, Mobitex, IEEE 801.11b, Wireless Application Protocol, Global System for Mobiles, etc., or a combination thereof.

The system 100 may include a directory 130. The directory 130 (or trusted-third-party) may be implemented on a computing platform similar to the peers 110a . . . 110n. The directory 130 may be configured to be trustworthy, i.e., not to modify or change information routed therethrough.

According to an embodiment of the present invention, a user of the peer 110a, as a requester, may request information (e.g., a file) from the peer 110n, as a data provider. The user of peer 110a may send a request for the selected information to the directory 130, which may be configured to determine if the selected information exists on the peer 110n. If the information is available on the peer 110n, a provider peer, the directory 130 may be configured to select a path from peer 110n to peer 110a from a data structure, e.g., a global path table.

The directory may be configured to generate an encryption key to encrypt the requested information. More particularly, the directory 130 may generate an encryption key utilizing an encryption algorithm such as DES, El Gamal, etc. The directory 130 may be further configured to form a retrieval message that comprises the encryption key encrypted with a public key of peer 110n and the path label for the selected path. Subsequently, the directory 130 may transmit the retrieval message to the peer 110n.

When the retrieval message is received at the provider peer, e.g., peer 110n, the provider peer may be configured to apply a complementary key to the encryption key encrypted with the public key of the provider peer, e.g., 110n, and temporarily store the encryption key. The provider peer, e.g., 110n, may then determine the next peer (or the peer following the provider peer) according to the selected path by searching a local hash table of the provider peer with the path label as a search index. The provider peer, e.g., 110n, may also instantiate (or form) a set-up message in order to form a persistent communication channel between the provider peer, e.g., 110n, and the requestor peer, e.g., 110a. The set-up message comprises the path label name for the selected path and is forwarded to the identified next peer.

When the message is received at an intermediary peer, such as peer 110c, the intermediary peer may be configured to form a persistent communication channel between itself and the sender (a previous peer according to the selected path) of the set-up message. The intermediary peer 110c may also be configured to forward the message to a next peer (e.g., peer 110b) by determining the next peer by searching a local hash table (not shown) of the intermediary peer 110c. More particularly, the intermediary peer 110c may use the received label as a search index to search the hash table for the next peer to forward the set-up message. If a peer is found in the hash table, the identity of the next peer is retrieved. The set-up message is forwarded to the next identified peer.

If a null entry is returned from the hash table, the intermediary peer, e.g., 110a, determines that it is the requester peer. As such, the requester peer, e.g., 110a, may transmit an acknowledgement message to the provider peer, e.g., 110n, to transmit the requested information that has been encrypted with the encryption key generated by the directory 130. The provider peer may also transmit the encryption key encrypted with the public key of the requestor peer.

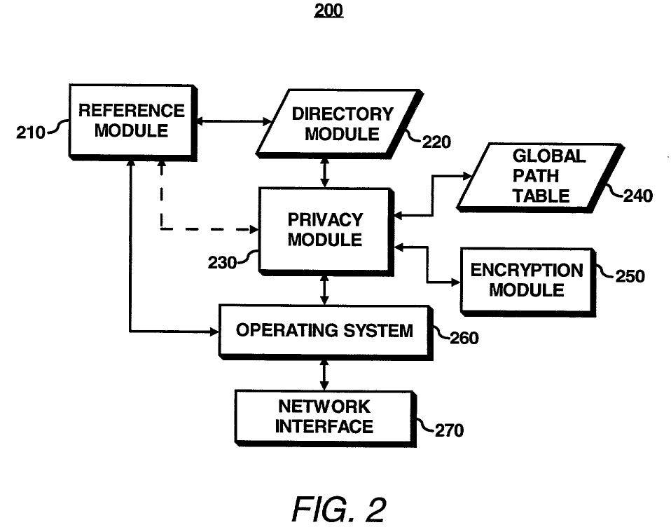

FIG. 2 illustrates an exemplary architecture 200 for the directory 130 shown in FIG. 1 in accordance with an embodiment of the present invention. It should be readily apparent to those of ordinary skill in the art that the architecture 200 depicted in FIG. 2 represents a generalized schematic illustration and that other components may be added or existing components may be removed or modified without departing from the spirit or scope of the present invention. Moreover, the architecture 200 may be implemented using software components, hardware components, or combinations thereof.

As shown in FIG. 2, the architecture 200 may include a reference module 210, a directory module 220, a directory privacy module 230, a global path table 240, an encryption module 250, an operating system 260, and a network interface 270. The reference module 210 may be configured to provide reference services for peers 110a . . . 110n in the network 120 through the operating system 250. The reference module 210 may periodically determine the types of information located within each peer of the data network system 100. The reference module 210 may also determine a location and/or existence of information (e.g., data, a file, etc.) in response to a request for information from a peer in the network 120.

The reference module 210 may be coupled to the directory module 220. In this respect, for example, the directory module 220 may be configured to provide database services for the reference module 210, i.e., provide the location of information among the peers 110a . . . 110n. The directory module 220 may be implemented as a database, a file, etc., within the directory 130. Alternatively, a lightweight directory access protocol server (LDAP, not shown) may be configured to provide the database services for the reference module 210.

The directory privacy module 230 may receive a request for information from a peer (a requestor peer) such as one of the peers 110a . . . 110n. If the information is available on a peer (i.e., the provider peer), the directory privacy module 230 may be configured to select a path from the provider peer to the requestor peer based on a random selection (or other selection criteria known to those skilled in the art such as least-recently-used, round robin, etc.). The directory privacy module 230 may also generate an encryption key for the requested information. The path label name for the selected path and the encryption key encrypted with the public key of the provider peer may then be transmitted to the provider peer in the form of a retrieval message.

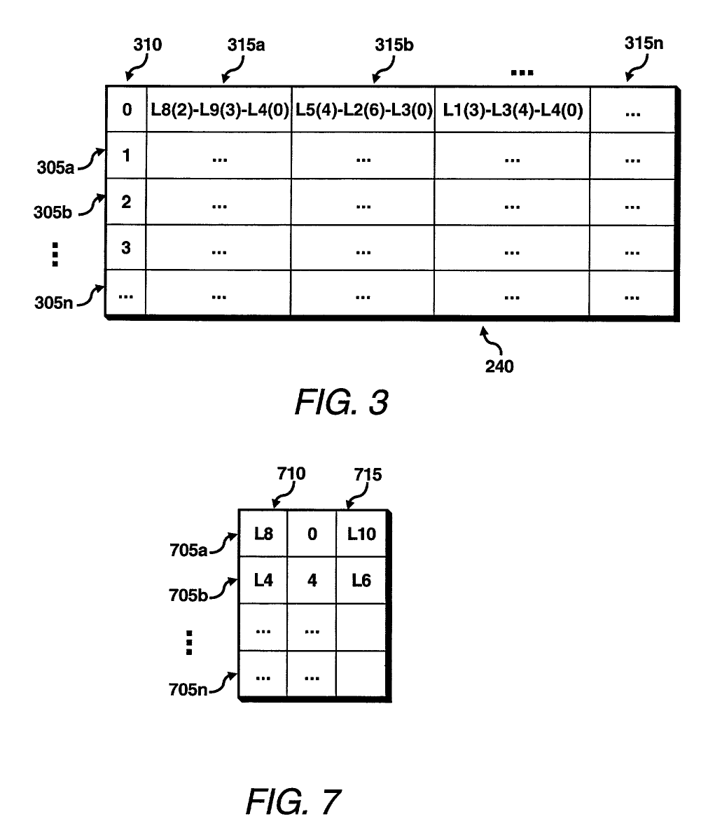

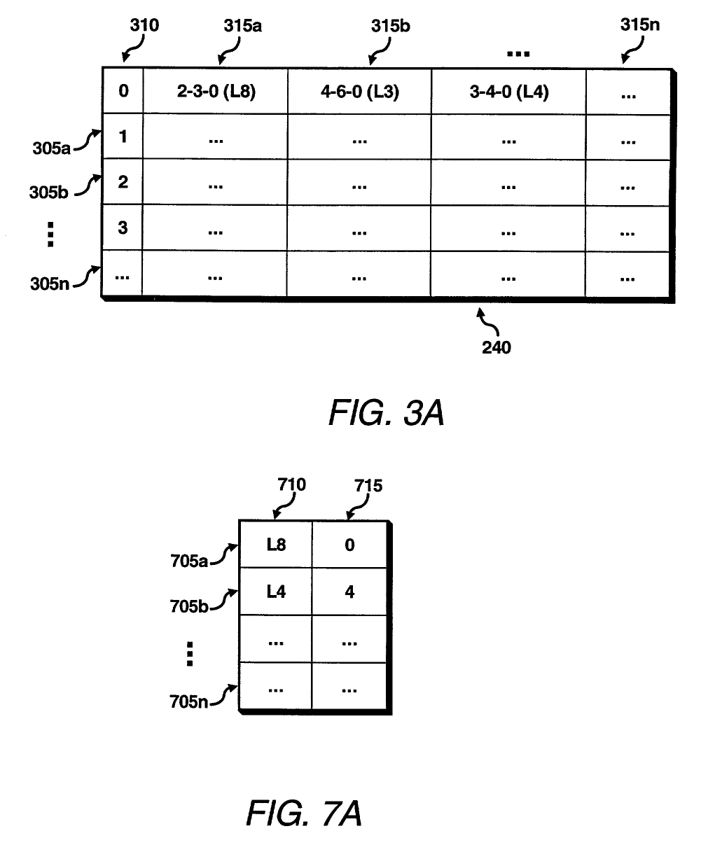

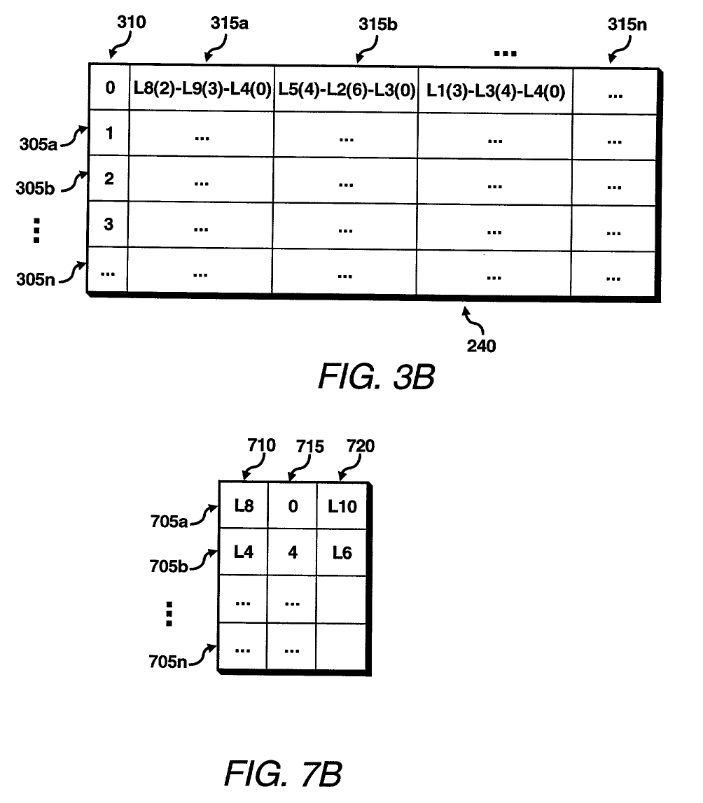

The directory privacy module 230 may also be configured to maintain the global path table 240, e.g., a table, a linked list, etc., that is configured to store a plurality of paths between the peers 110a . . . 110n, an example of is illustrated in FIG. 3.

FIG. 3A illustrates an exemplary global path table 240 shown in FIG. 2 in accordance with an embodiment of the present invention. It should be readily apparent to those of ordinary skill in the art that the global path table 240 depicted in FIG. 3A represents a generalized illustration and that other fields may be added or existing fields may be removed or modified without departing from the spirit or scope of the present invention.

As shown in FIG. 3A the global path table 240 may contain a plurality of path entries 305a . . . 305n. A path entry may correspond to a peer supported by the network 120. A path entry may comprise a peer field 310 and path fields 315a . . . 315n. Each path field, e.g., 315a, may contain a path to a peer and a unique path label name for the path. The directory privacy module 230 may be configured to update the global path table 240 with new paths for the peers 110a . . . 110n on a periodic basis or based on certain events (e.g., an addition of a new peer). The directory privacy module 230 may be configured to distribute to each of the peers 110a . . . 110n path tuple(s), where each path tuple comprises a path label name and the identity of the peer following a selected peer for a path identified by the path label name.

In accordance with another embodiment of the present invention, the directory privacy module 230 may select a unique path label for a path. The path label name may vary between peers along the selected path. For example, the directory privacy module 230 may select a path label of L8 for a peer. The peer may determine the next peer and change the label from L8 to L10. In this manner, anonymity may be increased along the anonymizing path. A single path label name may be subject to traffic analysis and thus, a breakdown in anonymity.

The directory privacy module 230 may also be configured to periodically modify the global path table 240. For example, the directory privacy module 230 may modify the length (i.e., the number of peers in a path), the participating peers in an anonymizing path, etc. The directory privacy module 230 may then send these modifications to the affected peers. Accordingly, the directory privacy module 230 may increase the level of anonymity. FIG. 3B illustrates an exemplary global path table 240 shown in FIG. 2 in accordance with another embodiment of the present invention. It should be readily apparent to those of ordinary skill in the art that the global path table 240 depicted in FIG. 3B represents a generalized illustration and that other fields may be added or existing fields may be removed or modified without departing from the spirit or scope of the present invention.

Similar to FIG. 3A, FIG. 3B shows that the global path table 240 may contain a plurality of path entries 305a . . . 305n. A path entry may correspond to a peer supported by the network 120. A path entry may comprise a peer field 310 and path fields 315a . . . 315n. Each path field, e.g., 315a, may contain a path to a peer with varying path label names for the path. In this example, a path label L8 identifies peer 2 as the next destination. Peer 2 would identify peer 3 for the path label L8 and peer 2 changes the path label to L9. Peer 2 then forwards the path label L9 to peer 3. Peer 3 identifies the next peer as peer 0 and changes the path label name to L4. Peer 3 then forwards the path label L4 to peer 0.

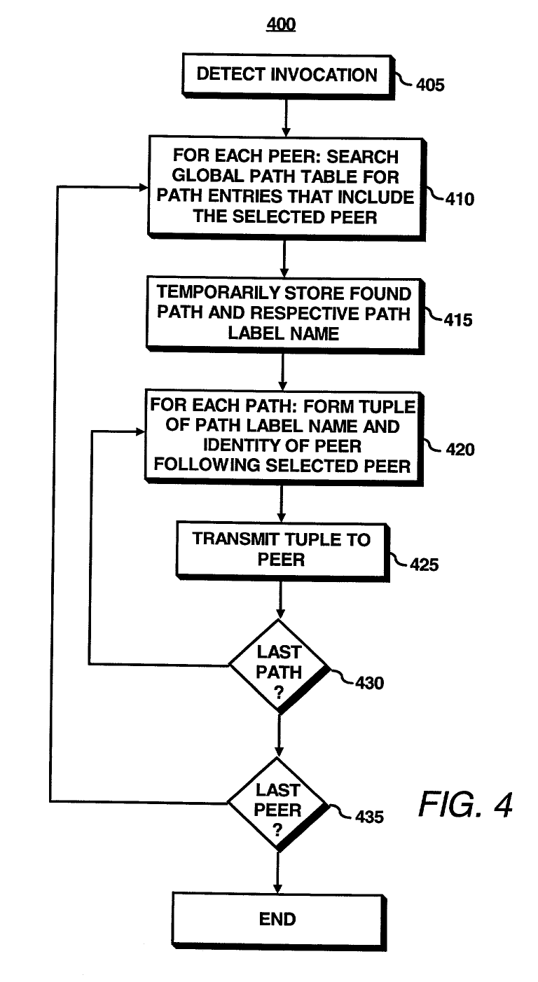

FIG. 4 illustrates an exemplary flow diagram of an operational mode 400 for the directory privacy module 230 shown in FIG. 2 in accordance with an embodiment of the present invention. It should be readily apparent to those of ordinary skill in the art that the operational mode 400 of the directory privacy module 230 represents a generalized illustration and that other steps may be added or existing steps may be removed or modified without departing from the spirit or scope of the present invention.

As shown in FIG. 4, the directory privacy module 230 may be configured to detect an invocation of the operational mode 400, in step 405. The invocation may be the result of a function call, a command, or other similar invocation technique known to those skilled in the art.

In step 410, the directory privacy module 230 may be configured to search the global path table 240 for all the paths associated with a selected peer. The paths associated with the selected peer along with the respective path label names may be temporarily stored in a memory space in an associated storage device (not shown) allocated by the directory privacy module 230, in step 415.

In step 420, the directory privacy module 230 may be configured to form a path tuple. The path tuple may comprise the path label name and the identity of the peer following the selected peer according to the path. If the selected peer is the last peer in the path, a null value may be substituted for the identity. In step 425, the directory privacy module 230 may transmit the path tuple to the selected peer. Alternatively, the directory privacy module 230 may temporarily store the path tuples generated in step 420 and transmit the generated path tuples simultaneously to the selected path tuple.

In step 430, the directory privacy module 230 may be configured to determine if the last path has been reached in the paths generated in step 415. If the last path has not been reached, the directory privacy module 230 may return to the processing of step 420.

Otherwise, if the last path has been reached, the directory privacy module 230 may determine whether the last peer in the global path table 240 has been processed in the manner described above. If the last peer has not been processed, the directory privacy module 230 may return to the processing of step 410. Otherwise, the directory privacy module 230 may end when the last peer has been processed.

Returning to FIG. 2, the directory privacy module 230 may be implemented as a software program, a utility, a subroutine, or other similar programming entity. In this respect, the directory privacy module 230 may be implemented using software languages such as C, C++, JAVA, etc. Alternatively, the directory privacy module 230 may be implemented as an electronic device utilizing an application specific integrated circuit, discrete components, solid-state components or combinations thereof.

The encryption module 250 may be configured to provide encryption and decryption services to the directory privacy module 230. For example, the encryption module 250 may generate encryption keys, decrypt encrypted information, etc. The encryption module 250 may use asymmetric, symmetric encryption algorithms or a combination thereof.

The directory privacy module 230 may be further configured to interface with the operating system 260. More specifically, the directory privacy module 230 may be interfaced with the operating system 260 through an application program interface (API, not shown). The operating system 260 may be configured to manage the software applications, data and respective hardware components (e.g., displays, disk drives, etc.) of a peer. MICROSOFT WINDOWS family of operating systems, UNIX, HEWLETT-PACKARD HP-UX, LINUX, RIM OS, and other similar operating systems may implement the operating system 260. Alternatively, the reference module 210 may be interfaced with the operating system 260 through the directory privacy module 230 or directly interfaced with the operating system 260.

The operating system 260 may be further configured to be coupled with the network interface 270 through a device driver (not shown). The network interface 270 may be configured to provide a communication port for the peer over the network 120 (shown in FIG. 1). The network interface 270 may be implemented by using a network interface card, a wireless interface card or other similar input/output device.

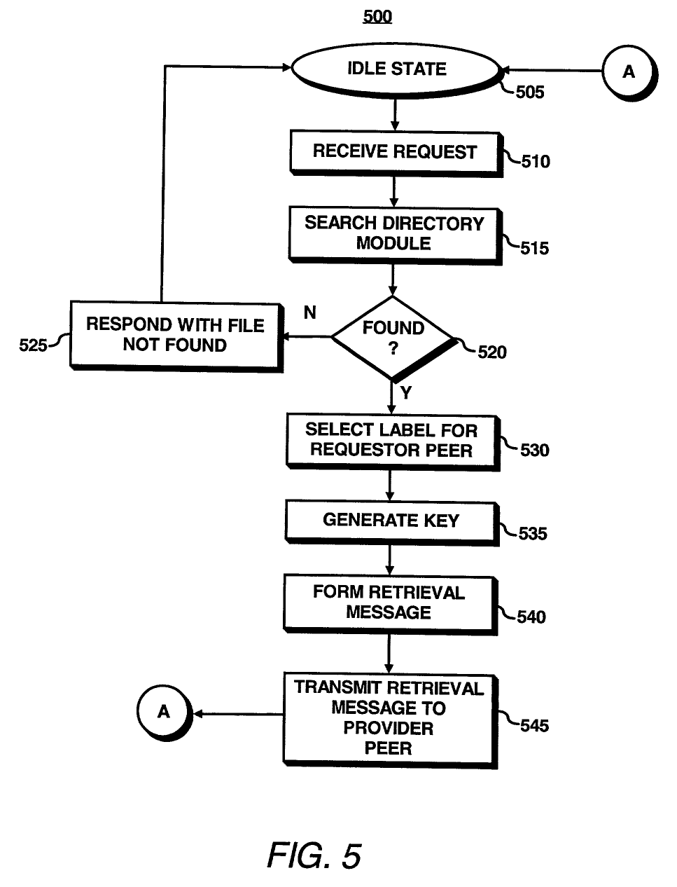

In accordance with another embodiment of the present invention, the directory privacy module 230 may be configured to respond to information requests from requestor peer, which is further illustrated in FIG. 5. FIG. 5 illustrates an exemplary flow diagram for an operational mode 500 of the directory privacy module 230 shown in FIG. 2 in accordance with an embodiment of the present invention.

It should be readily apparent to those of ordinary skill in the art that the first operational mode 500 of the directory privacy module 230 represents a generalized illustration and that other steps may be added or existing steps may be removed or modified without departing from the spirit or scope of the present invention.

As shown in FIG. 5, in step 505, the directory privacy module 230 of the directory 130 may be configured to be in an idle state. The directory privacy module 230 may receive a request for information (e.g., data, a file, etc.) from a requestor peer through the network interface 270, in step 510. The request may be in a format of a packet or message transmitted using the appropriate network protocol of the network 120.

In step 515, the directory privacy module 230 may be configured to search the directory module 220 for the requested information. The directory privacy module 230 may use the name of the requested information as an index into the directory module 220 to search for the peer(s) storing the requested information. Other techniques for querying information may be implemented and are within the scope of the present invention.

If the directory privacy module 230 determines that the requested information is not available on a peer in the system 100 (shown in FIG. 1), in step 520, the directory privacy module 230 may be configured to transmit a message to the requester peer that the requested information is not available, in step 525. Subsequently, the directory privacy module 230 may be configured to return to an idle state of step 505.

Otherwise, if the directory privacy module 230 determines that the requested information is available on a peer (now the provider peer), the directory privacy module 230 may randomly select a path from the global path table 240 from the provider peer to the requestor peer, in step 530. Alternatively, other selection criteria may be used to select the path such as round robin, least recently used, etc.

In step 535, the directory privacy module 230 may be configured to generate an encryption key for the requested information by invoking the encryption module 250. In step 540, the directory privacy module 230 may be configured to form a retrieval message, where the retrieval message comprises of the path label name and the encryption key encrypted with the public key of the provider peer.

In step 545, the retrieval message may be transmitted to the provider peer by the directory privacy module 230. Subsequently, the directory privacy module 230 may return to the idle state of 505.

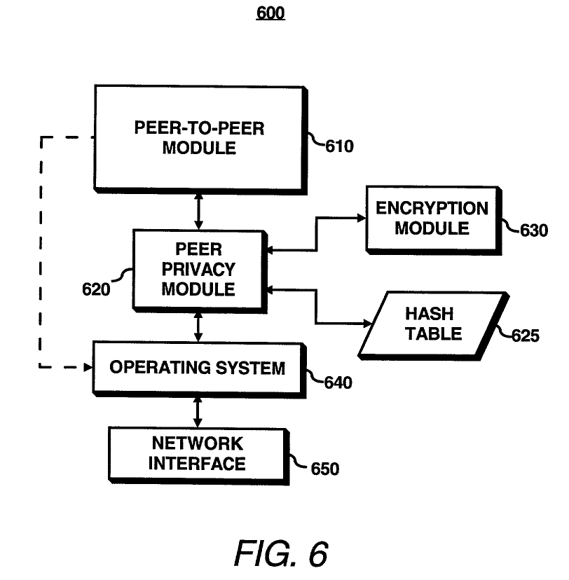

FIG. 6 illustrates an exemplary architecture 600 for a peer in the system 100 shown in FIG. 1 in accordance with an embodiment of the present invention. It should be readily apparent to those of ordinary skill in the art that the architecture 600 depicted in FIG. 6 represents a generalized schematic illustration and that other components may be added or existing components may be removed or modified without departing from the spirit or scope of the present invention. Moreover, the architecture 600 may be implemented using software components, hardware components, or a combination thereof.

As shown in FIG. 6, the architecture 600 may include a peer-to-peer module 610, a peer privacy module 620, a hash table 625, an encryption module 630, an operating system 640 and a network interface 650.

The peer-to-peer module 610 may be configured to provide the capability to a user of a peer to share information with another peer, i.e., each peer may initiate a communication session with another peer. The peer-to-peer module 610 may also be configured to determine which peers are valid. The validity information of the other peers in the system 100 may be made available to the peer privacy module 620.

The peer-to-peer module 610 may be a commercial off-the-shelf application program, a customized software application or other similar computer program. The peer-to-peer module 610 may be implemented by such programs such as KAZAA, NAPSTER, MORPHEUS or other similar peer-to-peer applications. Alternatively, the peer-to-peer module 610 may be configured to directly interface with the operating system 640.

The peer privacy module 620 may be configured to monitor an interface between the peer-to-peer module 610 and the operating system 640. The peer privacy module 620 may also be configured to substantially protect the identity of the peer when the peer requests information from another peer by utilizing the peer-to-peer module 610. More specifically, the peer privacy module 620 may send a message to a trusted-third-party such as the directory 130 shown in FIG. 1. If the directory 130 determines that the information is available in a peer, the directory 130 may send a retrieval message to the provider peer.

The peer privacy module 620 may be configured to receive a retrieval message from the directory 130. The retrieval message may include an encryption key encrypted with the public key of the provider peer and a path label name for the selected path from the provider peer to the requestor peer. The peer privacy module 620 may retrieve the path label name from the retrieval message and use the path label name to search the hash table 625 for the identity of the peer following the provider peer according to the path selected by the directory 130. The peer privacy module 620 may then instantiate a set-up message with the path label name and forward the set-up message to the identified next peer.

As the set-up message is forwarded through the network 120, persistent communication links are formed between the receiver and sender of the set-up message. Accordingly, a secure channel may eventually be formed between the provider peer and the requestor peer without the intermediary peers knowing the identity of the peers involved in the information transaction.

In another embodiment of the present invention, the peer privacy module 620 may be configured to receive a set-up message from another peer. The peer privacy module 620 may be configured to retrieve the path label name from the message and identify the next peer along the selected path by using the path label name as a search index into the hash table 625. If the search of the hash table 625 returns a null value, the peer privacy module 620 determines that the receiving peer is the final destination and transmit an acknowledgement message to the provider peer to transmit the requested information. The requested information may be encrypted with the encryption key and may also include the encryption key encrypted with the public key of the requestor peer. Otherwise, if the search of the hash table 625 returns an identity of the next peer, the peer privacy module 620 may forward the set-up message to the identified next peer.

The peer privacy module 620 may be implemented as a software program, a utility, a subroutine, or other similar programming entity. In this respect, the peer privacy module 620 may be implemented using software languages such as C, C++, JAVA, etc. Alternatively, the peer privacy module 620 may be implemented as an electronic device utilizing an application specific integrated circuit, discrete components, solid-state components or a combination thereof.

The hash table 625 may be a data structure configured to provide an identity of the next peer according to a selected path based on the path label name of the selected path. FIG. 7A illustrates an exemplary hash table 625 in accordance with an embodiment of the invention. It should be readily apparent to those of ordinary skill in the art that the hash table 625 depicted in FIG. 7A represents a generalized illustration and that other fields may be added or existing fields may be removed or modified without departing from the spirit or scope of the present invention.

As shown in FIG. 7A, the hash table 625 may include a number of entries 705a . . . 705n. Each entry comprises a path label name field 710 and a next peer field 715. The hash table 625 may be searched by using the path label name as a search index to return the identity of the next peer. The hash table 625 may be updated with path tuples transmitted from the directory 130.

FIG. 7B illustrates an exemplary hash table 625 in accordance with another embodiment of the invention. Similar to FIG. 7A, FIG. 7B shows a number of entries 705a . . . 705n for the hash table 625. Each entry comprises a path label name field 710, a next peer field 715 and a next path label name 720. The hash table 625 may be searched by using the path label name as a search index to return the identity of the next peer and the next path label name. The hash table 625 may be updated with path tuples transmitted from the directory 130.

Returning to FIG. 6, the peer privacy module 620 may be further configured to interface with an encryption module 630. The encryption module 630 may be configured to provide encryption and decryption services to the peer privacy module 620. For example, the encryption module 630 may generate encryption keys, decrypt encrypted information, etc. The encryption module 630 may use asymmetric or symmetric encryption algorithms. Each peer privacy module 620 may have an encryption key pair, a public and private (or complementary) key. The public key is distributed to the other peers including the directory 130. When the other peers and/or directory 130 require a secure means of transferring information to the peer privacy module 620, they may encrypt the information with the public key. The peer privacy module 620 may use the private key to decrypt the encrypted information, thus substantially increasing security for information exchanges.

The peer privacy module 620 may be further configured to interface with the operating system 640. More specifically, the peer privacy module 620 may be interfaced with the operating system 640 through an application program interface (API, not shown). The operating system 640 may be configured to manage the software applications, data and respective hardware components (e.g., displays, disk drives, etc.) of a peer. The MICROSOFT WINDOWS family of operating systems, UNIX, HEWLETT-PACKARD HP-UX, LINUX, RIM OS, and other similar operating systems may implement the operating system 640. Alternatively, the peer-to-peer module 610 may be directly interfaced with the operating system 640 where the peer privacy module 620 is monitoring the API.

The operating system 640 may be further configured to be coupled with the network interface 650 through a device driver (not shown). The network interface 650 may be configured to provide a communication port for the respective peer over the network 120 (shown in FIG. 1). The network interface 650 may be implemented using a network interface card, a wireless interface card or other similar input/output device.

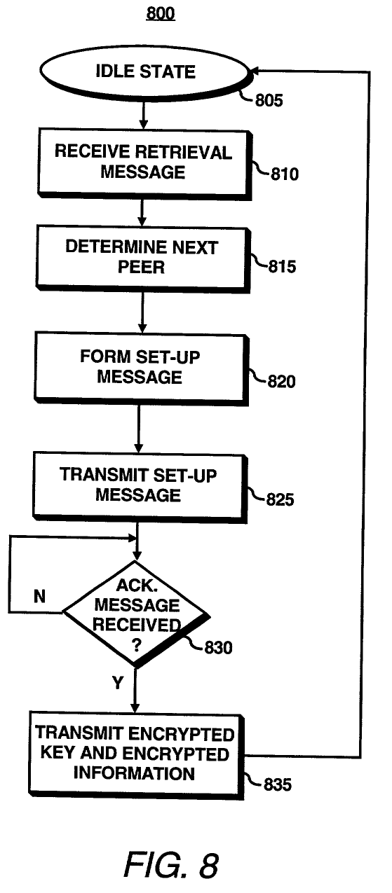

FIG. 8 illustrates an exemplary flow diagram of an operation mode 800 of the peer privacy module 620 shown in FIG. 6. It should be readily apparent to those of ordinary skill in the art that this operational mode 800 the peer privacy module 620 represents a generalized illustration and that other steps may be added or existing steps may be removed or modified without departing from the spirit or scope of the present invention.

As shown in FIG. 8, the peer privacy module 620 may be configured to be in an idle state in step 805. The peer privacy module 620 may monitor the network interface 650 via the operating system 640 for any received messages.

In step 810, the peer privacy module 620 may detect a retrieval message received through the network interface 650. The peer privacy module 620 may be configured to temporarily store the retrieval message for processing.

In step 815, the peer privacy module 620 may be configured to determine the identity of the next peer according to the selected path. More particularly, the peer privacy module 620 may search the hash table 625 with the path label name as a search index.

In step 820, the peer privacy module 620 may be configured to form a set-up message that may include at least the retrieved path label name. Subsequently, the peer privacy module 620 may transmit the set-up message to the identified next peer.

In step 830, the peer privacy module 620 may be configured to be in idle state by waiting for an acknowledgement message from the requester peer. If the acknowledgement message is received, the peer privacy module 620 may be configured to transmit the requested information encrypted with the encryption key and the encryption key encrypted with the public key of the requestor peer. Subsequently, the peer privacy module 620 may return to the idle state of 805.

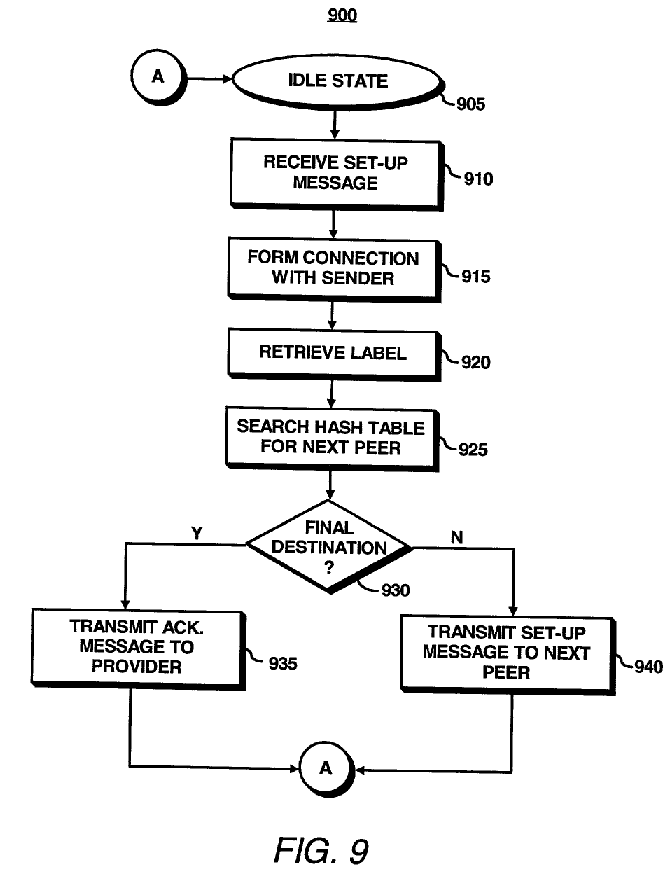

FIG. 9 illustrates an exemplary flow diagram for yet another operational mode 900 for the peer privacy module 620 shown in FIG. 2 in accordance with yet another embodiment of the present invention. It should be readily apparent to those of ordinary skill in the art that this operational mode of the peer privacy module 620 represents a generalized illustration and that other steps may be added or existing steps may be removed or modified without departing from the spirit or scope of the present invention.

As shown in FIG. 9, the peer privacy module 620 may be configured to be in an idle state in step 905. The peer privacy module 620 may monitor the network interface 650 via the operating system 640 (shown in FIG. 2) for any received messages.

In step 910, the peer privacy module 620 may detect a set-up message received through the network interface 650. The peer privacy module 620 may be configured to temporarily store the set-up message for processing. The set-up message may include the path label name for the path selected by the directory 130.

In step 915, the peer privacy module 620 may be configured to form a persistent communication channel (e.g., TCP/IP) with the sender of the set-up message.

In step 920, the peer privacy module 620 may be configured to extract the path label name from the received set-up message. Subsequently, in step 925, the peer privacy module 620 may be configured to search the hash table 625 with the label as a search index.

If the search of the hash table 625 returns a null value, in step 930, the peer privacy module 620 may be configured to transmit an acknowledgement message across the persistent communication channel to the provider peer, in step 935. Subsequently, the peer privacy module 620 may return to the processing of step 905.

Otherwise, if the search of the hash table 625 returns an identity of the next peer according to the selected path, the peer privacy module 620 may be configured to forward the set-up message to the identified next peer, in step 940. Subsequently, the peer privacy module 620 may return to the processing of step 905.

Alternatively, the peer privacy module 620 may identify the next peer and the next path label name, in step 930. The peer privacy module may then forward the next path label name to the identified next peer, in step 940. Subsequently, the peer privacy module 620 may return to the processing of step 905.

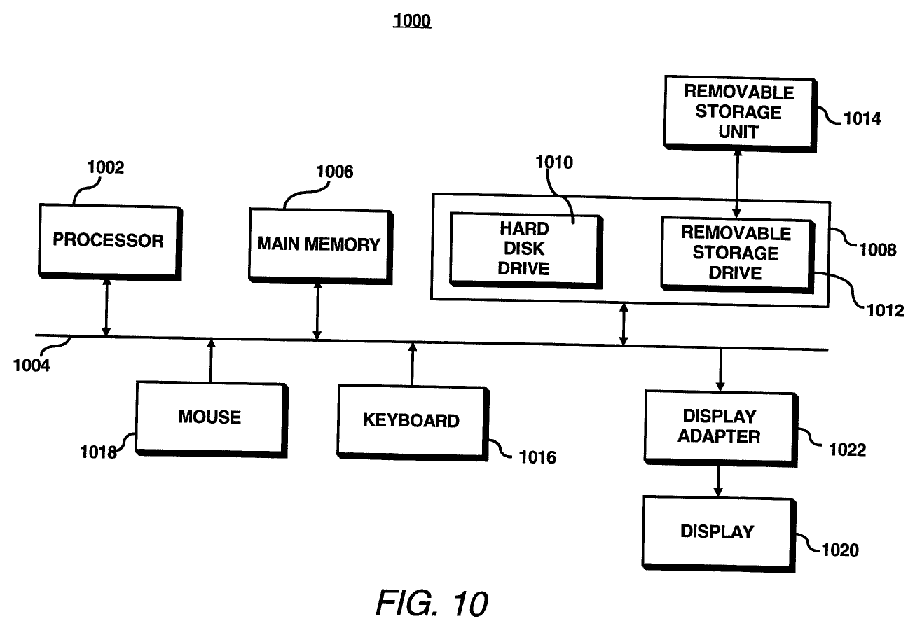

FIG. 10 illustrates an exemplary block diagram of a computer system 1000 where an embodiment of the present invention may be practiced. The functions of the peer privacy module 620 may be implemented in program code and executed by the computer system 1000. The peer privacy module 620 may be implemented in computer languages such as PASCAL, C, C++, JAVA, etc.

As shown in FIG. 10, the computer system 1000 includes one or more processors, such as processor 1002, that provide an execution platform for embodiments of the peer privacy module. Commands and data from the processor 1002 are communicated over a communication bus 1004. The computer system 1000 also includes a main memory 1006, such as a Random Access Memory (RAM), where the software for the peer privacy module may be executed during runtime, and a secondary memory 1008. The secondary memory 1008 includes, for example, a hard disk drive 1010 and/or a removable storage drive 1012, representing a floppy diskette drive, a magnetic tape drive, a compact disk drive, etc., where a copy of a computer program embodiment for the peer privacy module may be stored. The removable storage drive 1012 may read from and/or write to a removable storage unit 1014 in a well-known manner. A user interfaces with the peer privacy module with a keyboard 1016, a mouse 1018, and a display 1020. A display adaptor 1022 interfaces with the communication bus 1004 and the display 1020 and receives display data from the processor 1002 and converts the display data into display commands for the display 1020.

Certain embodiments of the present invention may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

What is claimed is:

1. A method of increasing privacy in a network system, comprising:
selecting a label in response to a request for information, said label configured to indicate a pre-determined path through a plurality of peers for said information;
forwarding said label to form a communication channel through said plurality of peers; and
transmitting said information through said communication channel.

2. The method according to claim 1, further comprising:
retrieving a subsequent peer according to said path in response to receiving said label at a receiving peer;
transmitting said label to said subsequent peer according to said path; and
opening a persistent connection from said receiving peer to said subsequent peer as a link of said communication channel.

3. The method according to claim 2, wherein said retrieval of said next peer further comprises:
searching a table of said receiving peer with said label as a search index.

4. The method according to claim 1, further comprising:
generating a plurality of paths, wherein each path is configured to include a combination of said plurality of peers and each path is also configured to have a respective label;
determining a sub-plurality of paths associated with a peer;
determining a plurality of subsequent peers for said peer, each subsequent peer following said peer according to a respective path of said sub-plurality of paths;
associating each subsequent peer with said respective label of each path of said sub-plurality of paths; and
transmitting each subsequent peer and said respective label to said peer.

5. The method according to claim 4, further comprising:
updating a hash table of said peer with each subsequent peer and said respective label.

6. The method according to claim 1, further comprising:
generating an encryption key;
encrypting said encryption key with a public key of a provider peer; and
encrypting said encryption key with a public key of a requester peer.

7. The method according to claim 6, further comprising:
selecting a path from a global path table;
determining a first peer subsequent to said provider peer according to said path;
forming a retrieval message, said retrieval message comprising:
said label;
said encryption key encrypted with said public key of said provider peer;
said encryption key encrypted with said public key of said requestor peer;
an identity of a first peer following said provider peer according to said path.

8. The method according to claim 7, further comprising:
re-transmitting said label to said first peer in response to receiving said retrieval message.

9. The method according to claim 8, further comprising:
forming a persistent connection between said first peer and said provider peer as a link of said communication channel in response to receiving said label.

10. The method according to claim 9, further comprising:
searching a table of said first peer by using said label as a search index;
retrieving a subsequent peer to said first peer from said hash table; and
transmitting said label to said subsequent peer.

11. A method of increasing privacy in a network, comprising:
generating a plurality of paths, wherein each path is configured to include a number of peers and each path is configured to have a respective path name;
determining a sub-plurality of paths associated with a selected peer;
determining a plurality of subsequent peers, each subsequent peer following said selected peer according to a respective path of said sub-plurality of paths; and
creating a plurality of path segments for said selected peer, each path segment comprising each subsequent peer of each path of said sub-plurality of paths and said respective path name of each path.

12. The method according to claim 11, further comprising:
receiving said plurality of path segments; and
storing said plurality of path segments in a table of said selected peer, wherein said table is configured to be searched by using a selected path name to retrieve a corresponding subsequent peer.

13. The method according to claim 11, further comprising:
receiving a request for information from a requester peer;
searching for said information; and
notifying said requestor peer of a non-availability of said information in response to a determination of non-availability of said information.

14. The method according to claim 11, further comprising:
receiving a request for information from a requestor peer;
searching for said information; and
transmitting a retrieval message to a provider peer in response to the determination of availability of said information.

15. The method according to claim 14, further comprising:
generating an encryption key;
encrypting said encryption key with a public key of said requester peer; and
encrypting said encryption key with a public key of said provider peer.

16. The method according to claim 15, further comprising:
selecting a transaction path from said plurality of paths; and
retrieving a respective path name of said transaction path.

17. The method according to claim 16, wherein said retrieval message comprises:
said respective path name of said transaction path;
said encryption key encrypted with said public key of said requestor peer;
said encryption key encrypted with said public key of said provider peer; and
said identity of a first peer following said provider peer according to said transaction path.

18. The method according to claim 17, further comprising:
transmitting a message to said first peer, said message comprising said respective path name; and
forming a persistent connection with said provider peer in response to receiving said message at said first peer.

19. The method according to claim 18, further comprising:
searching a table of said first peer with said respective path name as a search index into said table;
retrieving a peer subsequent to said first peer from said table; and
transmitting said respective path name to said peer subsequent to said first peer.

20. The method according to claim 19, further comprising:
receiving a respective path name at a current peer; and
forming a current persistent connection with a peer previous to said current peer according to said path.

21. The method according to claim 20, further comprising:
searching a table of said current peer with said respective path name as a current search index;
retrieving a peer following said current peer according to said path; and
transmitting said respective path name to said peer following said current peer.

22. A method of communicating with increased privacy, comprising:
transmitting a label for a selected path;
receiving said label at a current peer;
forming a persistent connection link of a communication channel from said current peer to a previous peer;
retrieving an identity of a peer following said current peer from a table of said current peer with said label as a search index; and
transmitting said label to said peer following said current peer.

23. The method according to claim 22, further comprising:
receiving said label at a requestor peer;
forming a last persistent connection link of said communication channel from said requester peer to a peer previous to said requester peer according to said selected path; and
notifying a provider peer of a completion of said communication channel between said requestor peer and a provider peer.

24. The method according to claim 23, further comprising:
transmitting information encrypted with an encryption key through said communication channel; and
transmitting said encryption key encrypted with a public key of said requestor peer.

25. A system for increasing privacy, comprising:
a plurality of peers;
a directory; and
a privacy module executing on said directory, wherein said privacy module is configured to select a label in response to a request for information, said label configured to indicate a pre-determined path through a plurality of peers for said information, to forward said label to form a communication channel through said plurality of peers, and to transmit said information through said communication channel.

26. The system according to claim 25, further comprising:
a peer privacy module configured to be executed on each of the peers, wherein said peer privacy module is configured to retrieve a subsequent peer according to said path in response to receiving said label, to transmit said label to said subsequent peer according to said path, and to open a persistent connection from said receiving peer to said subsequent peer as a link of said communication channel.

27. The system according to claim 26, the peer privacy module is further configured to search a table with said label as a search index.

28. The system according to claim 25, wherein said privacy module is configured to generate a plurality of paths, wherein each path is configured to include a combination of said plurality of peers and each path is also configured to have a respective label, to determine a sub-plurality of paths associated with a peer, and to determine a plurality of subsequent peers for said peer, each subsequent peer following said peer according to a respective path of said sub-plurality of paths.

29. The system according to claim 28, wherein said privacy module is configured to associate each subsequent peer with said respective label of each path of said sub-plurality of paths and to transmit each subsequent peer and said respective label to said peer.

30. The system according to claim 29, wherein said peer privacy module is configured to update a hash table of said peer with each subsequent peer and said respective label.

31. The system according to claim 25, wherein said privacy module is configured to generate an encryption key, to encrypt said encryption key with a public key of a provider peer, and to encrypt said encryption key with a public key of a requestor peer.

32. The system according to claim 31, wherein said privacy module is configured to select a path from a global path table, to determine a first peer subsequent to said provider peer according to said path, and to form a retrieval message comprising:
said label;
said encryption key encrypted with said public key of said provider peer;
said encryption key encrypted with said public key of said requestor peer; and
an identity of a first peer following said provider peer according to said path.

33. A system for increasing privacy, comprising:
a plurality of peers;
a directory; and
a privacy module executing on said directory, wherein said privacy module is configured to generate a plurality of paths, wherein each path is configured to include a number of peers and each path is configured to have a respective path name, to determine a sub-plurality of paths associated with a selected peer, to determine a plurality of subsequent peers, each subsequent peer following said selected peer according to a respective path of said sub-plurality of paths, and to create a plurality of path segments for said selected peer, each path segment comprising each subsequent peer of each path of said sub-plurality of paths and said respective path name of each path.

34. The system according to claim 33, further comprising:
a peer privacy module executing on each of the peers of said plurality of peers, said peer privacy module configured to receive said plurality of path segments and to store said plurality of path segments in a table of said selected peer, wherein said table is configured to be searched by using a selected path name to retrieve a corresponding subsequent peer.

35. The system according to claim 33, wherein said privacy module is configured to receive a request for information from a requestor peer and to notify said requester peer of a non-availability of said information in response to a determination of non-availability of said information.

36. The system according to claim 33, wherein said privacy module is configured to receive a request for information from a requestor peer and to transmit a retrieval message to a provider peer in response to a determination of availability of said information.

37. The system according to claim 36, wherein said privacy module is configured to generate an encryption key, to encrypt said encryption key with a public key of said requestor peer, and to encrypt said encryption key with a public key of said provider peer.

38. The system according to claim 33, wherein said privacy module is configured to select a transaction path from said plurality of paths and to retrieve respective path name of said path.

39. An apparatus for communicating with increased privacy, comprising:
means for transmitting a label for a selected path;
means for receiving said label at a current peer;
means for forming a persistent connection link of a communication channel from said current peer to a previous peer;
means for retrieving an identity of a peer following said current peer from a table of said current peer with said label as a current search index; and
means for transmitting said label to said peer following said current peer.

40. The apparatus according to claim 39, further comprising:
means for receiving said label at a requestor peer;
means for forming a last persistent connection link of said communication channel from said requestor peer to a peer previous to said requestor peer according to said selected path; and
means for notifying a provider peer of a completion of said communication channel between said requestor peer and a provider peer.

41. The apparatus according to claim 40, further comprising:
means for transmitting information encrypted with an encryption key through said communication channel; and
means for transmitting said encryption key encrypted with a public key of said requester peer.

42. An apparatus for increasing privacy in a network system, comprising:
means for selecting a label in response to a request for information, said label configured to indicate a predetermined path through a plurality of peers for said information;
means for forwarding said label to form a communication channel through said plurality of peers; and
means for transmitting said information through said communication channel.

43. The apparatus according to claim 42, further comprising:
means for retrieving a subsequent peer according to said path in response to receiving said label at a receiving peer;
means for transmitting said label to said subsequent peer according to said path; and
means for opening a persistent connection from said receiving peer to said subsequent peer as a link of said communication channel.

44. The apparatus according to claim 43, further comprising:
means for searching a table of said receiving peer with said label as a search index.

45. The apparatus according to claim 42, further comprising:
means for generating a plurality of paths, wherein each path is configured to include a combination of said plurality of peers and each path is also configured to have a respective label;
means for determining a sub-plurality of paths associated with a peer;
means for determining a plurality of subsequent peers for said peer, each subsequent peer following said peer according to a respective path of sub-plurality of paths;
means for associating each subsequent peer with said respective label of each path of sub-plurality of paths; and
means for transmitting each subsequent peer and said respective label to said peer.

46. The apparatus according to claim 45, further comprising:
means for updating a hash table of said peer with each subsequent peer and said respective label.

47. The apparatus according to claim 42, further comprising:
means for generating an encryption key;
means for encrypting said encryption key with a public key of a provider peer; and
means for encrypting said encryption key with a public key of a requestor peer.

48. The apparatus according to claim 47, further comprising:
means for selecting a path from a global path table;
means for determining a first peer subsequent to said provider peer according to said path; and
means for forming a retrieval message comprising:
said label;
said encryption key encrypted with said public key of said provider peer;
said encryption key encrypted with said public key of said requestor peer; and
an identity of a first peer following said provider peer according to said path.

49. The apparatus according to claim 48, further comprising:
means for re-transmitting said label to said first peer in response to receiving said retrieval message.

50. The apparatus according to claim 49, further comprising:
means for forming a persistent connection between said first peer and said provider peer as a link of said communication channel in response receiving said label.

51. The apparatus according to claim 50, further comprising:
means for searching a table of said first peer by using said label as a search index;
means for retrieving a subsequent peer to said first peer from said hash table; and
means for transmitting said label to said subsequent peer.

52. An apparatus for increasing privacy in a network, comprising:
means for generating a plurality of paths, wherein each path is configured to include a number of peers and each path is configured to have a respective path name;
means for determining a sub-plurality of paths associated with a selected peer;
means for determining a plurality of subsequent peers, each subsequent peer following said selected peer according to a respective path of said sub-plurality of paths; and
means for creating a plurality of path segments for said selected peer, each path segment comprising each subsequent peer of each path of said sub-plurality of paths and said respective path name of each path.

53. The apparatus according to claim 52, further comprising:
means for receiving said plurality of path segments; and
means for storing said plurality of path segments in a table of said selected peer, wherein said table is configured to be searched by using a selected path name to retrieve a corresponding subsequent peer.

54. The apparatus according to claim 52, further comprising:
means for receiving a request for information from a requester peer;
means for searching for said information; and
means for notifying said requester peer of a non-availability of said information in response to a determination of non-availability of said information.

55. The apparatus according to claim 52, further comprising:
means for receiving a request for information from a requestor peer;
means for searching for said information; and
means for transmitting a retrieval message to a provider peer in response to a determination of availability of said information.

56. The apparatus according to claim 55, further comprising:
means for generating an encryption key;
means for encrypting said encryption key with a public key of said requester peer; and
means for encrypting said encryption key with a public key of said provider peer.

57. The apparatus according to claim 56, further comprising:
means for selecting a transaction path from said plurality of paths; and
means for retrieving respective path name of said transaction path.

58. The apparatus according to claim 57, further comprising:
means for transmitting a message to said first peer, said message comprising said respective path name; and
means for forming a persistent connection with said provider peer in response to receiving said message at said first peer.

59. The apparatus according to claim 58, further comprising:
means for searching a table of said first peer with said respective label as a search index into said table;
means for retrieving a peer subsequent to said first peer from said table; and
means for transmitting said respective label to said peer subsequent to said first peer.

60. The apparatus according to claim 59, further comprising:
means for receiving respective label at a current peer; and
means for forming a current persistent connection with a peer previous to said current peer according to said path.

61. The apparatus according to claim 60, further comprising:
means for searching a table of said current peer with said respective label as a current search index;
means for retrieving a peer following said current peer according to said path; and
means for transmitting said respective label to said peer following said current peer.
